(19) United States
(12) Patent Application Publication
(10) Pub. No.: US 2020/0180533 A1
(43) Pub. Date: Jun. 11, 2020

(54) CONTROL SYSTEM, SERVER, IN-VEHICLE CONTROL DEVICE, VEHICLE, AND CONTROL METHOD

(71) Applicant: Toyota Jidosha Kabushiki Kaisha, Toyota-shi (JP)

(72) Inventors: Shin Sakurada, Toyota-shi (JP); Jun Okamoto, Nagoya-shi (JP); Josuke Yamane, Nissin-shi (JP); Risako Yamamoto, Toyota-shi (JP); Kazuki Sugie, Toyota-shi (JP); Masatoshi Komiyama, Handa-shi (JP)

(73) Assignee: Toyota Jidosha Kabushiki Kaisha, Toyota-shi (JP)

(21) Appl. No.: 16/671,441

(22) Filed: Nov. 1, 2019

(30) Foreign Application Priority Data
Dec. 11, 2018 (JP) 2018-231857

(51) Int. Cl. B60R 16/037; H04W 4/44; H04N 7/18; B60H 1/00; B60N 2/02

(52) U.S. Cl. CPC B60R 16/037; H04W 4/44; B60R 11/04; B60H 1/00742; B60N 2/0244; H04N 7/18

(57) ABSTRACT

A control system includes an in-vehicle control device and a server that transmit and receive information to and from each other. The in-vehicle control device includes: an image acquisition unit that acquires a captured image of an occupant; a setting state acquisition unit that acquires a setting state of equipment of a vehicle; and a transmission unit that transmits, to the server, the captured image or identification information regarding the occupant detected from the captured image, and the setting state. The server includes: a storage unit that stores setting information where the setting state and the occupant are associated with each other; and a transmission unit that transmits the setting state associated with the occupant to the in-vehicle control device or another in-vehicle control device when an image of the occupant is captured in the in-vehicle control device or the other in-vehicle control device after the setting information is stored.

### INCORPORATION BY REFERENCE

The disclosure of Japanese Patent Application No. 2018-231857 filed on Dec. 11, 2018 including the specification, drawings and abstract is incorporated herein by reference in its entirety.

### BACKGROUND

### 1. Technical Field

The disclosure relates to a control system, a server, an in-vehicle control device, a vehicle, and a control method.

### 2. Description of Related Art

An in-vehicle camera configured to capture an image of the inside of a vehicle has been used to monitor or record the condition of a passenger in the vehicle. As a technology using such an in-vehicle camera, a system configured to capture and recognize an image of the face of a passenger in a vehicle and control various kinds of equipment of the vehicle based on the image of the face is described in, for example, Japanese Unexamined Patent Application Publication No. 2001-097070 (JP 2001-097070 A).

### SUMMARY

According to the technology described in JP 2001-097070 A, the properties, such as the gender and age, of a passenger in a vehicle are identified based on an image of the passenger, and equipment of the vehicle is controlled in a manner corresponding to the properties of the passenger. Thus, the passenger is provided with Guidance on his/her behavior so as not to distract a driver's concentration on driving. However, there is still room for improvement in terms of contribution to enhancement of the comfort and convenience for all the occupants in a vehicle, including a driver and passengers.

The disclosure provides a control system, a server, an in-vehicle control device, a vehicle, and a control method that contribute to enhancement of the convenience for occupants in a vehicle.

A first aspect of the disclosure relates to a control system including an in-vehicle control device and a server that are configured to transmit and receive information to and from each other. The in-vehicle control device includes: an image acquisition unit configured to acquire a captured image of an occupant; a setting state acquisition unit configured to acquire a setting state of equipment of a vehicle; and a transmission unit configured to transmit, to the server, the captured image or identification information regarding the occupant detected from the captured image, and the setting state. The server includes: a storage unit configured to store setting information in which the setting state and the occupant are associated with each other; and a transmission unit configured to transmit the setting state associated with the occupant to the in-vehicle control device or another in-vehicle control device when an image of the occupant is captured in the in-vehicle control device or the other in-vehicle control device after the setting information is stored in the storage unit.

A second aspect of the disclosure relates to a server including: a receiving unit configured to receive, from an in-vehicle control device, a captured image of an occupant in a vehicle or information regarding the occupant detected from the captured image, and a setting state of equipment of the vehicle; a storage unit configured to store setting information in which the setting state and the occupant are associated with each other; and a transmission unit configured to transmit the setting state associated with the occupant to the in-vehicle control device or another in-vehicle control device when an image of the occupant is captured in the in-vehicle control device or the other in-vehicle control device after the setting information is stored in the storage unit.

A third aspect of the disclosure relates to an in-vehicle control device including: an image capturing unit configured to capture an image of an inside of a vehicle to generate a captured image of an occupant; a detection unit configured to detect a setting state of equipment of the vehicle; and a transmission unit configured to transmit the setting state and the captured image or information regarding the occupant detected from the captured image, to a server configured to store setting information in which the setting state and the occupant are associated with each other to transmit the setting state to the in-vehicle control device configured to capture an image of the occupant.

A fourth aspect of the disclosure relates to an in-vehicle control device including: an image capturing unit configured to capture an image of an inside of a vehicle to generate a captured image of an occupant; a transmission unit configured to transmit the captured image or information regarding the occupant detected from the captured image, to a server configured to store setting information in which a setting state of equipment of the vehicle and the occupant are associated with each other; a receiving unit configured to receive the setting state transmitted from the server; and a reproduction unit configured to output an instruction to reproduce the received setting state in the vehicle.

A fifth aspect of the disclosure relates to a control method for controlling an in-vehicle control device and a server that are configured to transmit and receive information to and from each other. The control method includes: capturing, by the in-vehicle control device, an image of an inside of a vehicle to generate a captured image of an occupant; acquiring, by the in-vehicle control device, a setting state of equipment of the vehicle; recognizing, by the in-vehicle control device or the server, the occupant from the captured image; storing, in the server, setting information in which the setting state and the occupant are associated with each other; transmitting, from the server, the setting state associated with the occupant to the in-vehicle control device or another in-vehicle control device when the in-vehicle control device or the other in-vehicle control device captures an image of the occupant after the setting information is stored; receiving, by the in-vehicle control device or the other in-vehicle control device, the setting state; and outputting, from the in-vehicle control device or the other in-vehicle control device, an instruction to reproduce the received setting state in the vehicle.

With the control system, the server, the in-vehicle control device, the vehicle, and the control method according to the disclosure, it is possible to enhance the convenience for occupants in a vehicle.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a diagram illustrating the configuration of a control system;

FIG. 2 is a diagram illustrating the configuration of a server;

FIG. 3 is a diagram illustrating the configuration of an in-vehicle control device and so forth;

FIG. 4A is a flowchart illustrating an operation of the in-vehicle control device;

FIG. 4B is a flowchart illustrating an operation of the server;

FIG. 5 is a diagram illustrating an example of setting information;

FIG. 6A is a flowchart illustrating an operation of the in-vehicle control device; and

FIG. 6B is a flowchart illustrating an operation of the server.

### DETAILED DESCRIPTION OF EMBODIMENTS

Hereinafter, an example embodiment will be described with reference to the accompanying drawings.

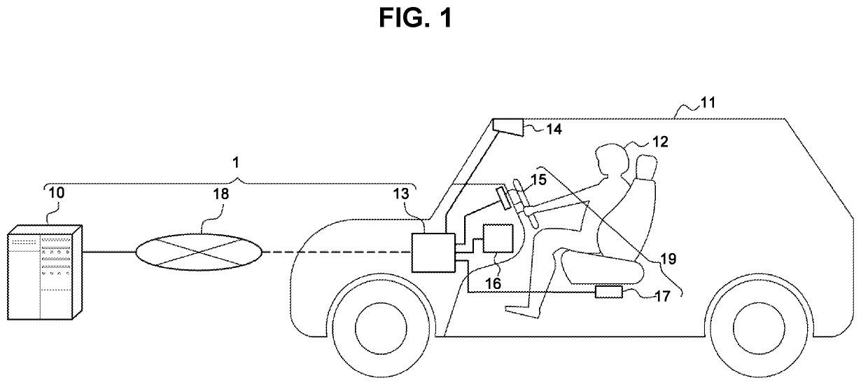

FIG. 1 illustrates the configuration of a control system 1 according to an embodiment. The control system 1 includes an in-vehicle control device 13 mounted in a vehicle 11, and a server 10. The server 10 and the in-vehicle control device 13 are communicably connected to each other via a network 18 by wire or wirelessly. The control system 1 may include two or more (i.e., a plurality of) in-vehicle control devices 13 mounted respectively in two or more vehicles 11. With this configuration, the server 10 and the in-vehicle control device 13 transmit and receive various kinds of information to and from each other.

Examples of the vehicle 11 include, but are not limited to, an automobile. The vehicle 11 may be any vehicle which a user can board. The vehicle 11 is provided with an image capturing device 14. The image capturing device 14 includes a built-in camera provided in or near a rearview mirror in a vehicle cabin of the vehicle 11 and configured to capture an image of the inside of the vehicle cabin. For example, from substantially the front of an occupant (a driver or a passenger) 12 who is aboard the vehicle 11 while facing the travelling direction of the vehicle 11, the built-in camera captures an image of the occupant 12 as a photographic subject. The vehicle 11 is further provided with various kinds of equipment, such as a navigation-AV (audio and visual) device 15, an air conditioning device 16, and a seat adjuster 17 (hereinafter, collectively referred to as “equipment 19”). The in-vehicle control device 13 is communicably connected to the image capturing device 14 and the equipment 19 via, for example, an in-vehicle local area network (LAN). The in-vehicle control device 13 detects a state of each of the image capturing device 14 and the equipment 19, and controls operations thereof.

When boarding the vehicle 11, the occupant 12 sets a setting state of the equipment 19 of the vehicle 11 depending on his/her preference or needs. Examples of the setting state of the equipment 19 include the air conditioning state, the height and angle of a seat, the music to listen to, the video to watch, and the travel destination (e.g., home, or workplace). Through cooperation between the in-vehicle control device 13 and the server 10, the control system 1 acquires and recognizes an image of the occupant 12, detects a setting state of the equipment 19 desired by the occupant 12, associates the occupant 12 and the desired setting state with each other, and stores, in the server 10, the information in which the occupant 12 and the desired setting state are associated with each other. After this, when the occupant 12 boards the same vehicle 11 or another vehicle 11, the occupant 12 is recognized based on a captured image, and the in-vehicle control device 13 acquires, from the server 10, the setting state corresponding to the occupant 12. In this way, the setting state desired by the occupant 12 can be acquired from the server 10, and the desired setting state can be reproduced any time, for example, not only when the occupant 12 boards his/her own vehicle but also when the occupant 12 boards a rental car. Thus, the comfort and convenience for the occupant 12 are enhanced. Furthermore, even when the occupant 12 boards, as a passenger, a passenger-carrying vehicle, such as a sharing car or a taxi, the setting state desired by the occupant 12 can be reproduced. Thus, a service provider of a passenger-carrying vehicle, such as a sharing car or a taxi, can improve their service quality. This is because the vehicle state desired by each occupant can be reproduced by recognizing, in a passenger-carrying vehicle, the occupant based on his/her image.

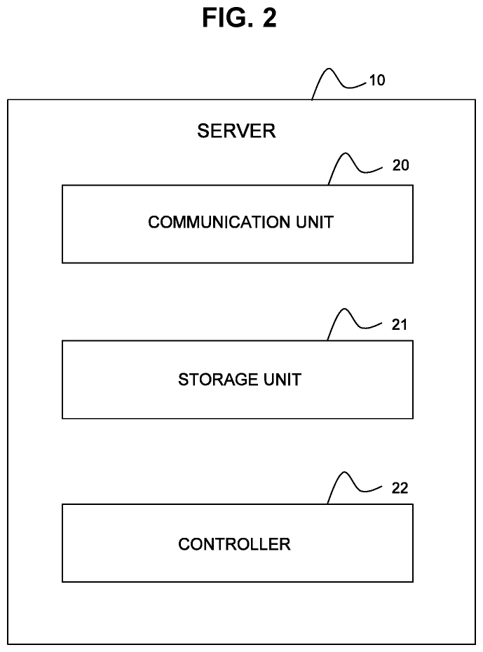

FIG. 2 illustrates the configuration of the server 10. The server 10 includes a communication unit 20, a storage unit 21, and a controller 22. The server 10 is composed of one computer or two or more computers configured to communicate with each other.

The communication unit 20 includes one or more communication modules connected to the network 18. The communication unit 20 may include, for example, a communication module that complies with a wired LAN (local area network) standard. In the present embodiment, the server 10 is connected at the communication unit 20 to the network 18.

The storage unit 21 includes one or more memories. Each memory included in the storage unit 21 may function as, for example, a main memory, an auxiliary memory, or a cache memory. The storage unit 21 stores any given information, control and processing programs, and databases that are used for operations of the server 10.

The controller 22 includes one or more processors. Each processor may be, but is not limited to, a general-purpose processor, or a processor dedicated to specific processing. The controller 22 controls operations of the server 10 according to the control and processing programs stored in the storage unit 21. The controller 22 has a timer function of obtaining the current time.

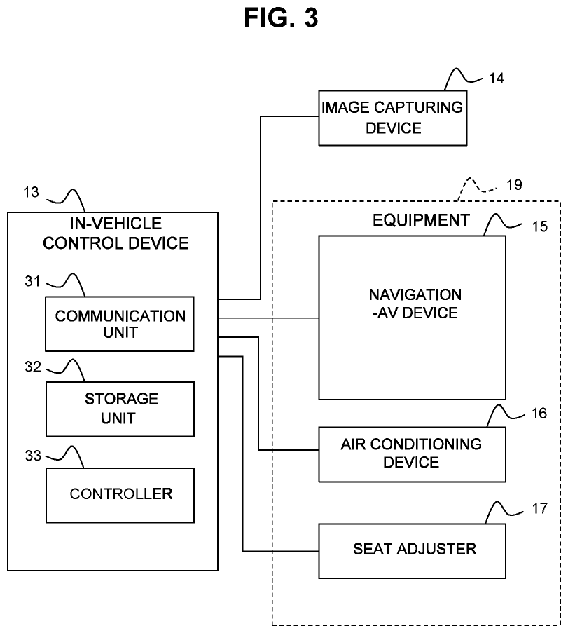

FIG. 3 illustrates the configuration of the in-vehicle control device 13, and the configuration of the equipment 19, such as the navigation-AV device 15, the air conditioning device 16, and the seat adjuster 17, which are provided in the vehicle 11. The in-vehicle control device 13 includes a communication unit 31, a storage unit 32, and a controller 33. The in-vehicle control device 13 may be composed of a single device or a plurality of devices. The in-vehicle control device 13 is communicably connected to the image capturing device 14 and the equipment 19 via, for example, the in-vehicle LAN. The in-vehicle control device 13 detects a state of each of the image capturing device 14 and the equipment 19, and controls operations thereof. Further, the in-vehicle control device 13 is connected to various sensors (not illustrated) configured to detect various motion states of the vehicle 11, such as a vehicle speed, a braking force of a brake, an acceleration, a steering angle, a yaw rate, and bearings. The in-vehicle control device 13 acquires detection results from these sensors.

The communication unit 31 of the in-vehicle control device 13 includes one or more communication modules. The communication module includes a module that complies with a mobile communication standard, such as 4G (4th Generation) or 5G (5th Generation). The communication unit 31 may include a communication device, such as a data communication module (DCM). The in-vehicle control device 13 is connected at the communication unit 31 to the network 18, and performs information communication with the server 10. The communication module includes a global positioning system (GPS) receiver module. The communication unit 31 of the in-vehicle control device 13 receives a GPS signal. The communication unit 31 includes an interface connected to the in-vehicle LAN of the vehicle 11. The communication unit 31 performs information communication with the image capturing device 14, the equipment 19, various sensors, and so forth via the in-vehicle LAN.

The storage unit 32 of the in-vehicle control device 13 includes one or more memories. Examples of each memory of the storage unit 32 include, but are not limited to, a semiconductor memory, a magnetic memory, or an optic memory. Each memory functions as, for example, a main memory, an auxiliary memory, or a cache memory. The storage unit 32 stores any given information used for operations of the in-vehicle control device 13. The storage unit 32 stores, for example, control and processing programs, built-in software, and so forth.

The controller 33 of the in-vehicle control device 13 includes one or more processors. Each processor may be, but is not limited to, a general-purpose processor, or a processor dedicated to specific processing. For example, an electronic control unit (ECU) mounted in the vehicle 11 may function as the controller 33. The controller 33 collectively controls the operations of the in-vehicle control device 13. The controller 33 collects information indicating the state of the equipment 19, thereby detecting the state of the equipment 19, and transmits, to the equipment 19, a control signal for controlling the operation of the equipment 19. The controller 33 has a timer function of obtaining the current time.

The image capturing device 14 includes the built-in camera configured to capture an image of the inside of the vehicle cabin of the vehicle 11 under the control of the in-vehicle control device 13, and a control circuit for the built-in camera. The camera included in the image capturing device 14 may be a monocular camera or a stereo camera. In response to an instruction from the controller 33, the image capturing device 14 captures an image of the occupant 12, as a photographic subject, in the vehicle cabin, generates captured image data, and transmits the captured image data to the controller 33.

The navigation-AV device 15 provides route guidance to a destination input by the occupant 12. Further, the navigation-AV device 15 acquires, from the communication unit 31 of the in-vehicle control device 13, audio data and image data transmitted via broadcasting or the network 18, or retrieves audio data and image data from an internal storage unit, and then outputs audio and an image. The navigation-AV device 15 includes any given input interface, such as a touch screen configured to receive a touch input by the occupant 12, or a microphone configured to receive an audio input by the occupant 12, and any given output interface configured to output various kinds of information to the occupant 12, such as a panel display, a head-up display, or a speaker. The input and output interfaces may be provided at a plurality of places including not only the driver's seat but also a rear seat of the vehicle 11. The navigation-AV device 15 transmits the setting state to the in-vehicle control device 13. In this case, examples of the setting state include the destination and preference on a route (e.g., whether to use a toll road) that are set by the occupant 12, and the broadcast station and the distribution station, the specific program, the specific music or video, and the like that are selected by the occupant 12. Alternatively, the navigation-AV device 15 makes its setting based on the setting state sent from the in-vehicle control device 13.

The air-conditioning device 16 includes an air-conditioner, an operation unit for the air-conditioner, and a control circuit for the air-conditioner. In response to an operation performed by the occupant 12, the air-conditioning device 16 performs cooling, heating, dehumidification, ventilation, or the like in the vehicle cabin. The air-conditioning device 16 transmits the setting state to the in-vehicle control device 13. In this case, examples of the setting state include the function (cooling, heating, dehumidification, ventilation, or the like) and the set temperature that are selected by the occupant 12. Alternatively, the air-conditioning device 16 makes its setting based on the setting state transmitted from the in-vehicle control device 13.

The seat adjuster 17 includes an actuator that is driven to adjust the height of a seat in which the occupant 12 is seated, the position of the seat in the front-rear direction, the angle of a backrest of the seat, or the like, an operation unit for the actuator, and a control circuit for the actuator. In response to an operation performed by the occupant 12, the seat adjuster 17 adjusts the height of the seat, the position of the seat in the front-rear direction, the angle of the backrest, or the like. The seat adjuster 17 transmits the setting state to the in-vehicle control device 13. In this case, examples of the setting state include the height of the seat, the position of the seat in the front-rear direction, and the angle of the backrest that are selected by the occupant 12. Alternatively, the seat adjuster 17 makes its setting based on the setting state transmitted from the in-vehicle control device 13.

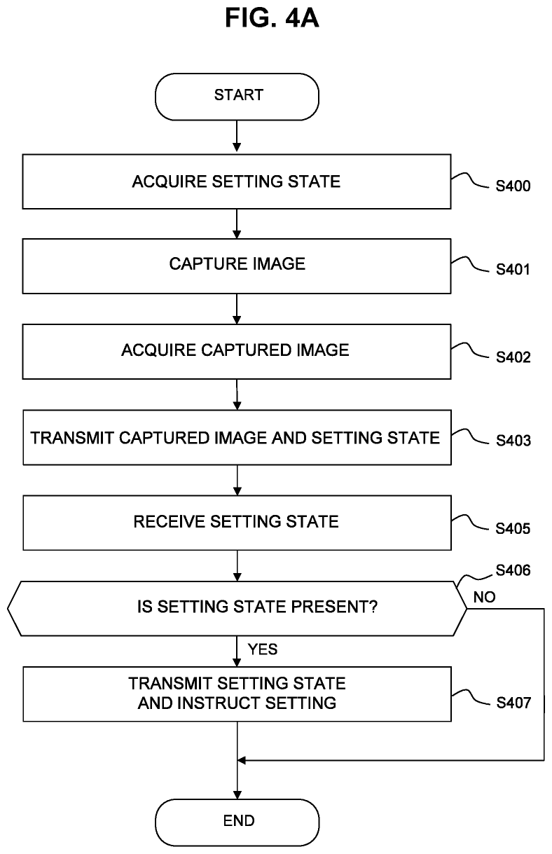

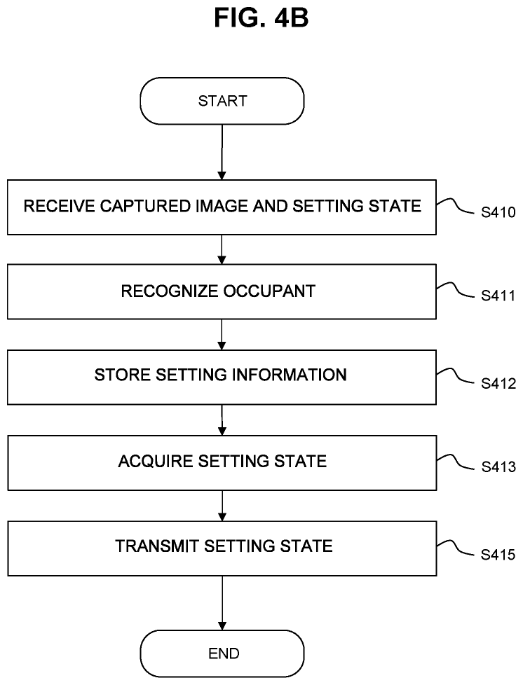

Next, operations of the control system 1 will be described with reference to FIG. 4A and FIG. 4B.

FIG. 4A is a flowchart illustrating an operation sequence for the in-vehicle control device 13. FIG. 4B is a flowchart illustrating an operation sequence for the server 10 that operates in response to the operation of the in-vehicle control device 13.

The sequence of FIG. 4A is performed at a predetermined cycle (e.g., at a cycle of several seconds to several tens of seconds) during a period, for example, from the time when the in-vehicle control device 13 is turned on after the occupant 12 boards the vehicle 11, to the time when the vehicle 11 starts to travel (e.g., to the time when an increase in the vehicle speed, release of the brake, or the like, is detected). First, the in-vehicle control device 13 acquires a setting state of each of the devices in the equipment 19, such as the navigation-AV device 15, the air conditioning device 16, and the seat adjuster 17 (step S400). For example, the controller 33 of the in-vehicle control device 13 exchanges various kinds of information with the equipment 19 via the communication unit 31. The controller 33 requests the equipment 19 to send the setting state, and each device in the equipment 19 sends, to the in-vehicle control device 13, information indicating the setting state set by the occupant 12. When no setting has been made by the occupant 12, the equipment 19 sends, to the in-vehicle control device 13, information indicating that no setting has been made, as the setting state. Here, the controller 33 performs step S400 to implement the function of “setting state acquisition unit”.

Subsequently, the in-vehicle control device 13 causes the image capturing device 14 to capture an image of the occupant 12 (step S401), and acquires captured image data (step S402). Then, the in-vehicle control device 13 transmits, to the server 10, the captured image data and the setting state of each device in the equipment 19 (step S403). For example, the controller 33 sends an image-capturing instruction to the image capturing device 14 via the communication unit 31, and the image capturing device 14 captures an image of the occupant 12 in response to the instruction. Then, the image capturing device 14 sends the captured image data to the in-vehicle control device 13, and the controller 33 acquires the captured image data via the communication unit 31. Here, the controller 33 performs step S402 to implement the function of “image acquisition unit”. Then, the controller 33 transmits, to the server 10 via the communication unit 31, the information indicating the setting state (including the state in which no setting has been made) of each device in the equipment 19, and the captured image data.

Subsequently, as illustrated in FIG. 4B, the server 10 receives the captured image data and the setting state (step S410), and recognizes the occupant 12 (step S411). In the server 10, for example, the controller 22 receives, from the in-vehicle control device 13 via the communication unit 20, the information indicating the setting state and the captured image data. Then, the controller 22 recognizes the occupant 12 by performing image recognition processing, such as edge detection and pattern recognition, on the captured image data. A single occupant 12 may be recognized, or a plurality of occupants 12 may be recognized.

Subsequently, the server 10 associates the setting state of each device in the equipment 19 with the occupant 12, and stores the setting state associated with the occupant 12 (step S412). For example, the controller 22 causes the storage unit 21 to store setting information in which identification information regarding the occupant 12 and the setting state are associated with each other. At this time, the controller 22 causes the storage unit 21 to store the setting state of the device on which setting has been made, among the devices in the equipment 19. In addition, when there are two or more occupants 12, the controller 22 may cause the storage unit 21 to store setting information in which each occupant 12 and the setting state corresponding to the occupant 12 are associated with each other.

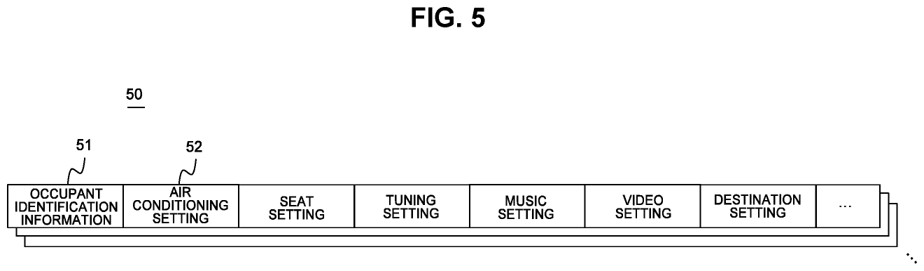

For example, as illustrated in FIG. 5, the storage unit 21 stores setting information 50 in which occupant identification information 51 for identifying the occupant 12 and a setting state 52 are associated with each other. The occupant identification information 51 includes, for example, an identification (ID) for uniquely identifying the occupant 12. The setting state 52 includes: air conditioning setting on the function (cooling, heating, or ventilation) and the temperature that are to be achieved by the air conditioning device 16; seat setting on the height of the seat, the position of the seat in the front-rear direction, and the angle of the backrest of the seat that are to be achieved by the seat adjuster 17; tuning setting on the selection of the broadcast station and the distribution station; music setting on the selection of the music to be output; video setting on the selection of the video to be output; destination setting on the destination for the route guidance; and so forth. The tuning setting, the music setting, the video setting, and the destination setting are to be achieved by the navigation-AV device 15. The music setting and the video setting include information, such as the location of data to be acquired, in the distribution station or the storage unit. Here, the setting state stored in the storage unit 21 is the setting state of the device, among the devices in the equipment 19, which has been set by the occupant 12 and which has been received from the in-vehicle control device 13. In a case where the setting state 52 that has been already stored is present in the storage unit 21 and then the setting state set by the occupant 12 is received from the in-vehicle control device 13, the setting state 52 is updated to the new setting state. In addition, the current time may be associated with the setting information 50, and, for example, the air conditioning setting that varies depending on the season, and the tuning setting, the music setting, the video setting, or the destination setting that varies by time of day may be stored. Further, not only the destination setting but also the route search conditions (whether a higher priority is given to a toll road, an expressway, or the like) may be included in the setting state 52. As such, it is possible to store the setting information that more accurately reflects the desire of the occupant 12.

Referring back to FIG. 4B, subsequently, the server 10 acquires the setting state associated with the occupant 12 (step S413), and then transmits the acquired setting state to the in-vehicle control device 13 (step S415). For example, the controller 22 retrieves, from the storage unit 21, the setting state that has already been stored in the storage unit 21 and that has not been updated in step S412, that is, the setting state to be reproduced for the occupant 12 in the vehicle 11. Then, the controller 22 transmits the information indicating the retrieved setting state to the in-vehicle control device 13 via the communication unit 20. Here, when the stored setting state is not present or when the setting state has just been updated in step S412, the controller 22 transmits, to the in-vehicle control device 13, the information indicating that no setting has been made.

Subsequently, as illustrated in FIG. 4A, the in-vehicle control device 13 receives the setting state (step S405). When the received setting state includes a setting state to be reproduced in the vehicle 11 (Yes in step S406), the in-vehicle control device 13 transmits, to the corresponding device in the equipment 19, the setting state to be reproduced and instructs the corresponding device in the equipment 19 to make the setting (step S407). On the other hand, when the received setting state does not include a setting state to be reproduced in the vehicle 11 (No in step S406), the in-vehicle control device 13 ends the processing. For example, when the controller 33 receives the setting state from the server 10 via the communication unit 31 and the received setting state includes a setting state to be reproduced, the controller 33 sends the setting state to be reproduced and an instruction to make the setting, to the corresponding device via the communication unit 31. For example, when the setting state received from the server 10 includes air conditioning setting to be reproduced, the controller 33 transmits the air conditioning setting to the air conditioning device 16 and instructs the air conditioning device 16 to make the setting. When the setting state received from the server 10 includes seat setting to be reproduced, the controller 33 transmits the seat setting to the seat adjuster 17 and instructs the seat adjuster 17 to make the setting. When the setting state received from the server 10 includes tuning setting, music setting, video setting, or destination setting to be reproduced, the controller 33 transmits the tuning setting, music setting, video setting, or destination setting to the navigation-AV device 15 and instructs the navigation-AV device 15 to make the setting. Here, the controller 33 performs step S407 to implement the function of “reproduction unit”.

In the device that has received the setting state, among the devices in the equipment 19, a control circuit receives the setting state and makes its setting based on the received setting state. For example, in the air conditioning device 16, the kind of air conditioning (e.g., cooling, heating, or ventilation) and the temperature are set based on the received setting state. In the seat adjuster 17, the height of the seat, the position of the seat in the front-rear direction, the angle of the backrest are set based on the received setting state. In the navigation-AV device 15, the broadcasting station, the distribution station, the music to be output, the video to be output, or the destination of the route guidance are set based on the received setting state. Then, the equipment 19 operates according to the setting, so that the setting state desired by the occupant 12 is reproduced.

In the foregoing embodiment, when two or more occupants 12 board the vehicle 11 and setting states vary among the occupants 12, the server 10 may, for example, give a higher priority to the setting state associated with the occupant 12 in the driver's seat (i.e., the driver), or may give a higher priority to the setting state associated with the occupant 12 in the front seat than to the setting state associated with the occupant 12 in the rear seat. Note that, the priority order may be changed depending on the kind of setting state. For example, regarding the air conditioning setting, a higher priority may be given to the setting state associated with the driver. Regarding the audio setting and the video setting, a higher priority may be given to the setting states associated with the occupant 12 in the passenger's seat or in the rear seat.

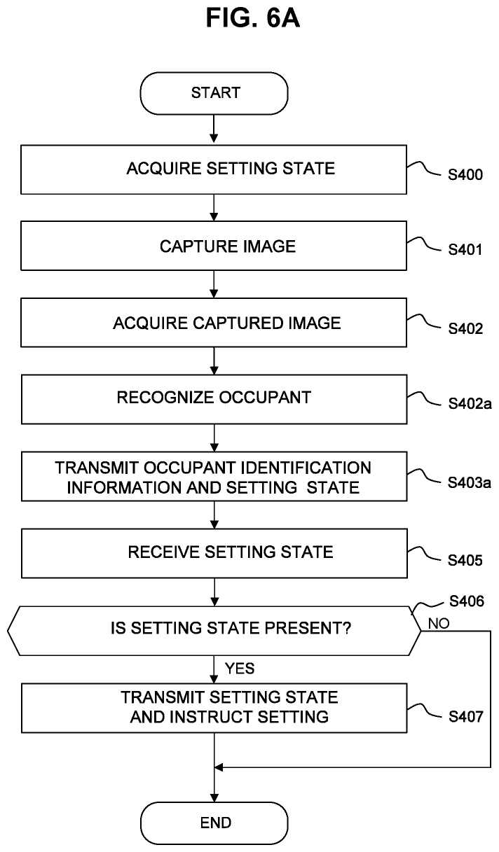

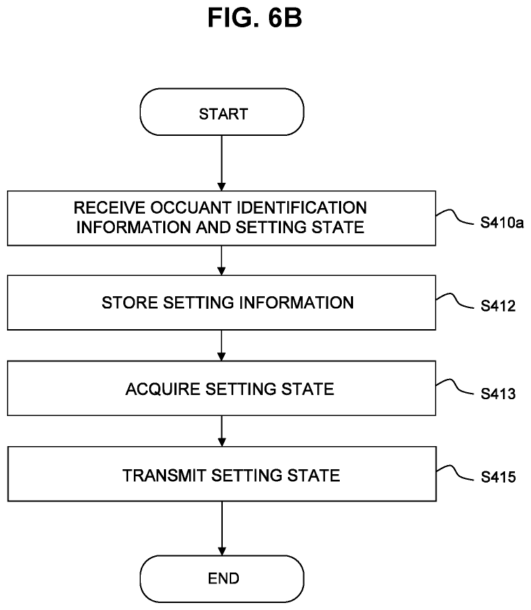

FIG. 6A is a flowchart illustrating an operation sequence for the in-vehicle control device 13 in a modified example. FIG. 6B is a flowchart illustrating an operation sequence for the server 10 in the modified example. In FIG. 6A and FIG. 6B, the same steps as those in FIG. 4A and FIG. 4B are denoted by the same reference signs as those in FIG. 4A and FIG. 4B, and the steps different from those in FIG. 4A and FIG. 4B are denoted by reference signs different from those in FIG. 4A and FIG. 4B. The description on the same steps as those in FIG. 4A and FIG. 4B will be omitted.

In the modified example, the in-vehicle control device 13 acquires the captured image in step S402, and then recognizes the occupant 12 based on the captured image data (step S402a). Then, the in-vehicle control device 13 transmits the occupant identification information and the setting state to the server 10 (step S403a), and then the server 10 receives the occupant identification information and the setting state (step S410a) and stores them in step S412. In this modified example, the in-vehicle control device 13 performs the recognition of the occupant 12, so that a processing load on the server 10 can be reduced.

In the sequences of FIG. 4A and FIG. 6A, before transmitting the setting state to be reproduced to the equipment 19 and instructs the equipment 19 to make the setting in step S407, the in-vehicle control device 13 may output (e.g., display) the setting state to the output interface of the navigation-AV device 15, thereby prompting the occupant 12 to make a judgement. In this case, the setting state and an instruction are sent to the equipment 19 in response to an input from the occupant 12. As such, it is possible to avoid a situation where an inappropriate setting that does not reflect a change in the occupant 12's preference or need is made.

While the example embodiments have been described with reference to the drawings, it is to be noted that a person skilled in the art can easily make various changes and modifications to the foregoing embodiments based on the present disclosure. Therefore, it is also to be noted that these changes and modifications fall within the scope of the disclosure. For example, functions included in the above-described elements and steps may be rearranged as long as long as theoretical contradictions do not occur. For example, two or more elements or steps may be combined into one element or step or one element or step may be divided into a plurality of elements or steps. In addition, programs that enable the controller 22 of the server 10 and the controller 33 of the in-vehicle control device 13 to perform operations in the forgoing embodiment are also included within the scope of the disclosure.

Examples of the network 18 in the foregoing embodiment may include, in addition to the network described above, an ad-hoc network, a local area network (LAN), a metropolitan area network (MAN), a cellular network, a wireless personal area network (WPAN), a public switched telephone network (PSTN), a terrestrial wireless network, an optical network, and other networks, and any combination of these networks. Elements of a wireless network include, for example, an access point (e.g., a Wi-Fi access point), and a femtocell. Moreover, the communication module can be connected to a wireless network using Bluetooth®, Wi-Fi®, a cellular communication technology or another wireless technology, and a technology standard.

As described above, various features of the present disclosure can be implemented in various forms, and such forms are all included within the scope of the foregoing embodiments.

What is claimed is:

1. A control system comprising:
an in-vehicle control device; and
a server that are configured to transmit and receive information to and from each other, wherein
the in-vehicle control device includes
an image acquisition unit configured to acquire a captured image of an occupant,
a setting state acquisition unit configured to acquire a setting state of equipment of a vehicle, and
a transmission unit configured to transmit, to the server, the captured image or identification information regarding the occupant detected from the captured image, and the setting state, and
the server includes
a storage unit configured to store setting information in which the setting state and the occupant are associated with each other, and
a transmission unit configured to transmit the setting state associated with the occupant to the in-vehicle control device or another in-vehicle control device when an image of the occupant is captured in the in-vehicle control device or the other in-vehicle control device after the setting information is stored in the storage unit.

2. The control system according to claim 1, wherein the in-vehicle control device or the other in-vehicle control device includes: a receiving unit configured to receive the setting state transmitted from the server; and a reproduction unit configured to output an instruction to reproduce the received setting state in the vehicle.

3. The control system according to claim 1, wherein the setting state includes any one of an air conditioning setting state, a seat setting state, a music setting state, a video setting state, and a travel destination setting state.

4. A server comprising:
a receiving unit configured to receive, from an in-vehicle control device, a captured image of an occupant in a vehicle or information regarding the occupant detected from the captured image, and a setting state of equipment of the vehicle;
a storage unit configured to store setting information in which the setting state and the occupant are associated with each other; and
a transmission unit configured to transmit the setting state associated with the occupant to the in-vehicle control device or another in-vehicle control device when an image of the occupant is captured in the in-vehicle control device or the other in-vehicle control device after the setting information is stored in the storage unit.

5. An in-vehicle control device comprising:
an image capturing unit configured to capture an image of an inside of a vehicle to generate a captured image of an occupant;
a detection unit configured to detect a setting state of equipment of the vehicle; and
a transmission unit configured to transmit the setting state and the captured image or information regarding the occupant detected from the captured image, to a server configured to store setting information in which the setting state and the occupant are associated with each other to transmit the setting state to the in-vehicle control device configured to capture an image of the occupant.

6. A vehicle comprising the in-vehicle control device according to claim 5.

7. An in-vehicle control device comprising:
an image capturing unit configured to capture an image of an inside of a vehicle to generate a captured image of an occupant;
a transmission unit configured to transmit the captured image or information regarding the occupant detected from the captured image, to a server configured to store setting information in which a setting state of equipment of the vehicle and the occupant are associated with each other;
a receiving unit configured to receive the setting state transmitted from the server; and
a reproduction unit configured to output an instruction to reproduce the received setting state in the vehicle.

8. A vehicle comprising the in-vehicle control device according to claim 7.

9. A control method for controlling an in-vehicle control device and a server that are configured to transmit and receive information to and from each other, the control method comprising:
capturing, by the in-vehicle control device, an image of an inside of a vehicle to generate a captured image of an occupant;
acquiring, by the in-vehicle control device, a setting state of equipment of the vehicle;
recognizing, by the in-vehicle control device or the server, the occupant from the captured image;
storing, in the server, setting information in which the setting state and the occupant are associated with each other;
transmitting, from the server, the setting state associated with the occupant to the in-vehicle control device or another in-vehicle control device when the in-vehicle control device or the other in-vehicle control device captures an image of the occupant after the setting information is stored;
receiving, by the in-vehicle control device or the other in-vehicle control device, the setting state; and
outputting, from the in-vehicle control device or the other in-vehicle control device, an instruction to reproduce the received setting state in the vehicle.
